(19) United States
(12) Patent Application Publication
(10) Pub. No.: US 2008/0079883 A1
(43) Pub. Date: Apr. 3, 2008

(54) LIQUID CRYSTAL DISPLAY

(75) Inventors: Sung-Hoon YANG, Yongin-si (KR); So-Woon KIM, Suwon-si (KR); Kyoung-ju SHIN, Hwaseong-si (KR); Mee-Hye JUNG, Suwon-si (KR); Chong-Chul CHAI, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/860,904

(22) Filed: Sep. 25, 2007

(30) Foreign Application Priority Data
Sep. 29, 2006 (KR) 10-2006-0096074

(51) Int. Cl. G02F 1/1343

(52) U.S. Cl. 349/142

(57) ABSTRACT

The present invention provides a liquid crystal display including a first insulation substrate, gate lines disposed on the first insulation substrate, data lines insulated from and crossing the gate lines, thin film transistors connected to the gate lines and the data lines, and pixel electrodes divided into a plurality of regions by first domain dividers and connected to the thin film transistors. The first domain dividers include a plurality of first notches and the width of each first domain dividers increases or decreases in a region between the first notches.

### CROSS REFERENCE TO RELATED APPLICATION

This application claims priority from and the benefit of Korean Patent Application No. 10-2006-0096074, filed on Sep. 29, 2006, which is hereby incorporated by reference for all purposes as if fully set forth herein.

### BACKGROUND OF THE INVENTION

1. Field of the Invention

The present invention relates to a liquid crystal display, and more particularly, to a liquid crystal display that may have excellent side visibility and prevent the sudden appearance of residual images.

2. Discussion of the Background

Liquid crystal displays are widely used as flat panel displays. A liquid crystal display typically includes two display panels on which field generating electrodes such as pixel electrodes and common electrodes are formed, and a liquid crystal layer interposed between the panels. In the liquid crystal display, voltage is applied to the field generating electrodes to generate an electric field and the alignment of the liquid crystal molecules of the liquid crystal layer is determined by the electric field. Accordingly, the polarization of incident light is controlled, thereby displaying an image.

Vertically aligned (VA) mode liquid crystal displays, in which the major axes of liquid crystal molecules are perpendicular to the upper and lower display panels in a state in which an electric field is not applied, have received attention because of their large contrast ratios and wide reference viewing angles. In order to achieve a wide viewing angle in a vertically aligned mode liquid crystal display, gaps may be formed in a field generating electrode and protrusions may be formed above or below the field generating electrode.

In a patterned vertical alignment (PVA) mode liquid crystal display including gaps, each display region in the pixels is divided into a plurality of regions by the gaps, and the liquid crystal molecules in each pixel are inclined in the same direction. That is, the gaps form a lateral electric field, so that liquid crystal molecules in one pixel are inclined in the same direction. Further, liquid crystal molecules are uniformly inclined in four directions, so that it may be possible to ensure a wide viewing angle.

However, the direction of the electric field is not constant in the gaps. For this reason, liquid crystal molecules provided in the gaps move slower than liquid crystal molecules provided in the domains. This may result in the sudden appearance of residual images. In particular, a point at which directors of the liquid crystal molecules converge is called a singular point. Singular points are not formed at constant positions in the gaps and the positions of singular points change during the operation of the liquid crystal display when each driving voltage is applied to the pixels. For this reason, residual images appear.

### SUMMARY OF THE INVENTION

This invention provides a liquid crystal display that may have excellent side visibility and prevent the sudden appearance of residual images.

Additional features of the invention will be set forth in the description which follows, and in part will be apparent from the description, or may be learned by practice of the invention.

The present invention discloses a liquid crystal display including a first insulation substrate, gate lines disposed on the first insulation substrate, data lines insulated from and crossing the gate lines, thin film transistors connected to the gate lines and the data lines, and pixel electrodes divided into a plurality of regions by first domain dividers and connected to the thin film transistors. The first domain dividers include a plurality of first notches and the width of each first domain divider increases or decreases in a region between the first notches.

The present invention also discloses a liquid crystal display including a first insulation substrate, first gate lines and second gate lines separated from each other and disposed on the first insulation substrate, data lines insulated from and crossing the first gate lines and the second gate lines, and first thin film transistors and second thin film transistors connected to the first gate lines and the second gate lines and the data lines, respectively. The liquid crystal display further includes a first sub-pixel electrode connected to the first thin film transistor and a second pixel electrode separated from the first sub-pixel electrode by first domain dividers and connected to the second thin film transistor. The first domain dividers include a plurality of first notches and the width of each first domain divider increases or decreases in a region between the first notches.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a layout view of a thin film transistor array panel for a liquid crystal display according to an exemplary embodiment of the present invention.

FIG. 2 is a cross-sectional view of the thin film transistor array panel shown in FIG. 1 taken along line II-II′.

FIG. 3 is a layout view of a common electrode panel for a liquid crystal display according to the exemplary embodiment of the present invention.

FIG. 4 is a layout view of a liquid crystal display that includes the thin film transistor array panel shown in FIG. 1 and the common electrode panel shown in FIG. 3.

FIG. 5 is a cross-sectional view of the liquid crystal display shown in FIG. 4 taken along line V-V′.

FIG. 6 is an enlarged layout view of the gaps of the pixel electrode and the common electrode shown in FIG. 4.

FIG. 7A shows the initial arrangement of liquid crystal molecules provided at the gaps after an electric field is applied between the pixel electrode and the common electrode.

FIG. 7B shows the final arrangement of liquid crystal molecules provided at the gaps after an electric field is applied between the pixel electrode and the common electrode.

FIG. 8 is a layout view of a thin film transistor array panel for a liquid crystal display according to another exemplary embodiment of the present invention.

FIG. 9 is a layout view of a common electrode panel for the liquid crystal display according to another exemplary embodiment of the present invention.

FIG. 10 is a layout view of a liquid crystal display that includes the thin film transistor array panel shown in FIG. 8 and the common electrode panel shown in FIG. 9.

FIG. 11 is a layout view showing gaps of a pixel electrode and the common electrode shown in FIG. 10.

FIG. 12 is an enlarged layout view of the gaps of the pixel electrode and the common electrode shown in FIG. 11.

FIG. 13 is a circuit diagram of the liquid crystal display shown in FIG. 10.

FIG. 14 is a layout view of a thin film transistor array panel for a liquid crystal display according to still another exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough and complete, and will fully convey the scope of the invention to those skilled in the art. In the drawings, the size and relative sizes of layers and regions may be exaggerated for clarity. Like reference numerals in the drawings denote like elements.

It will be understood that when an element or a layer is referred to as being “on” or “connected to” another element or layer, it can be directly on or directly connected to the other element or layer, or intervening elements or layers may also be present. In contrast, when an element is referred to as being “directly on” of “directly connected to” another element or layer, there are no intervening elements of layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

A liquid crystal display according to the present invention includes a thin film transistor array panel, a common electrode panel, and a liquid crystal layer. The thin film transistor array panel includes thin film transistors that are connected to gate lines and data lines and apply voltages to pixel electrodes. The common electrode panel faces the thin film transistor array panel and includes common electrodes. The liquid crystal layer is interposed between the thin film transistor array panel and the common electrode panel so that a major axis of a liquid crystal molecule is aligned to be substantially perpendicular to the panels.

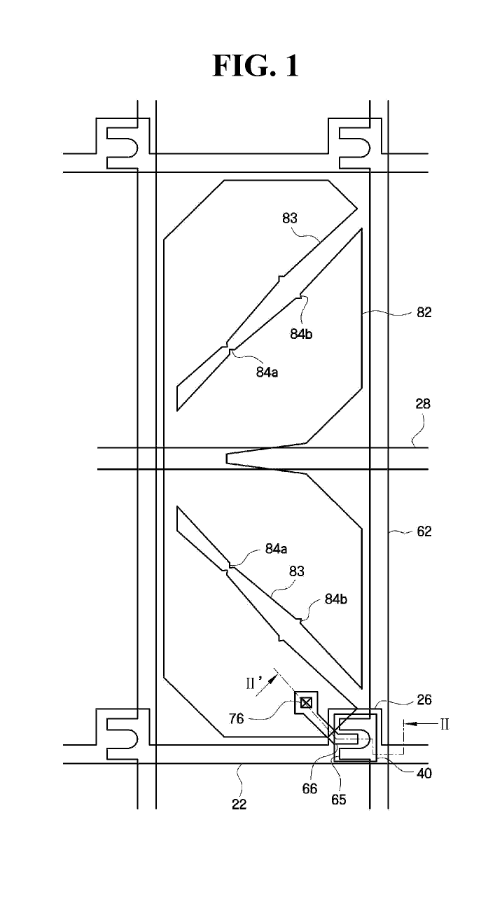

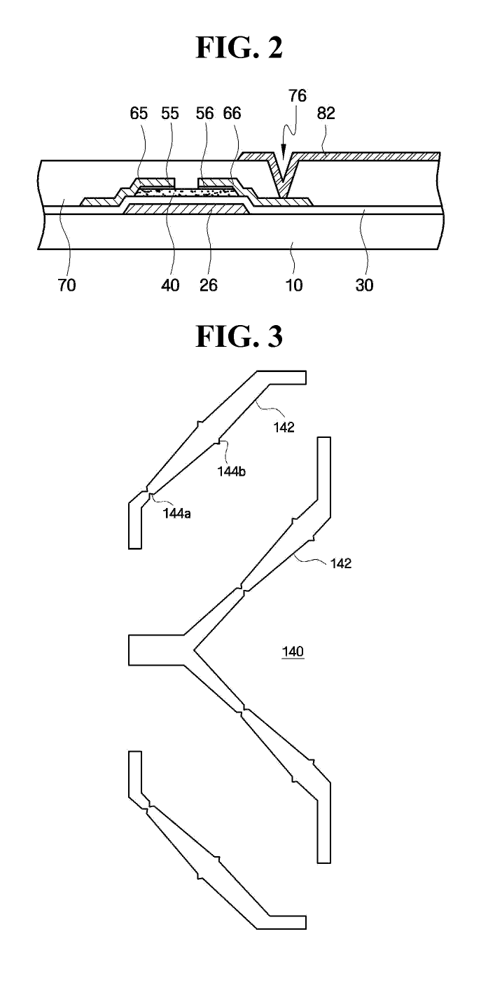

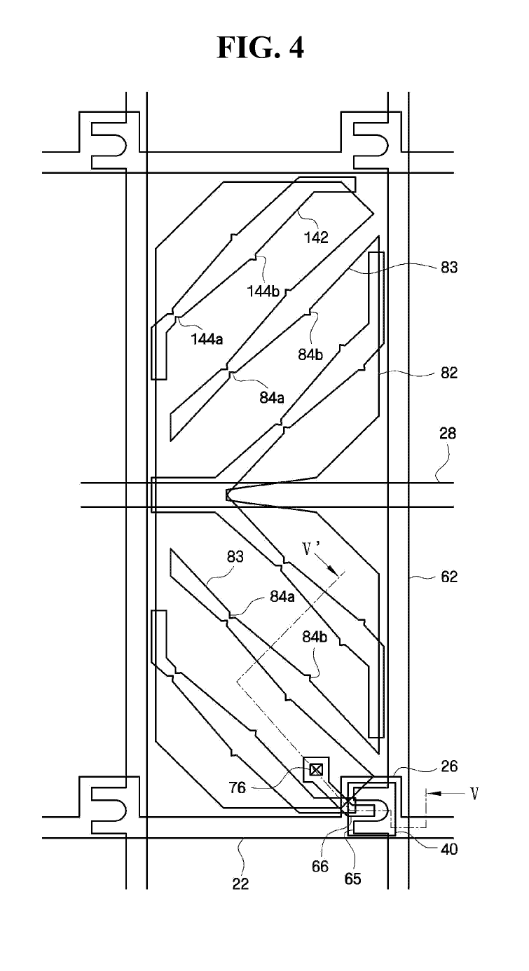

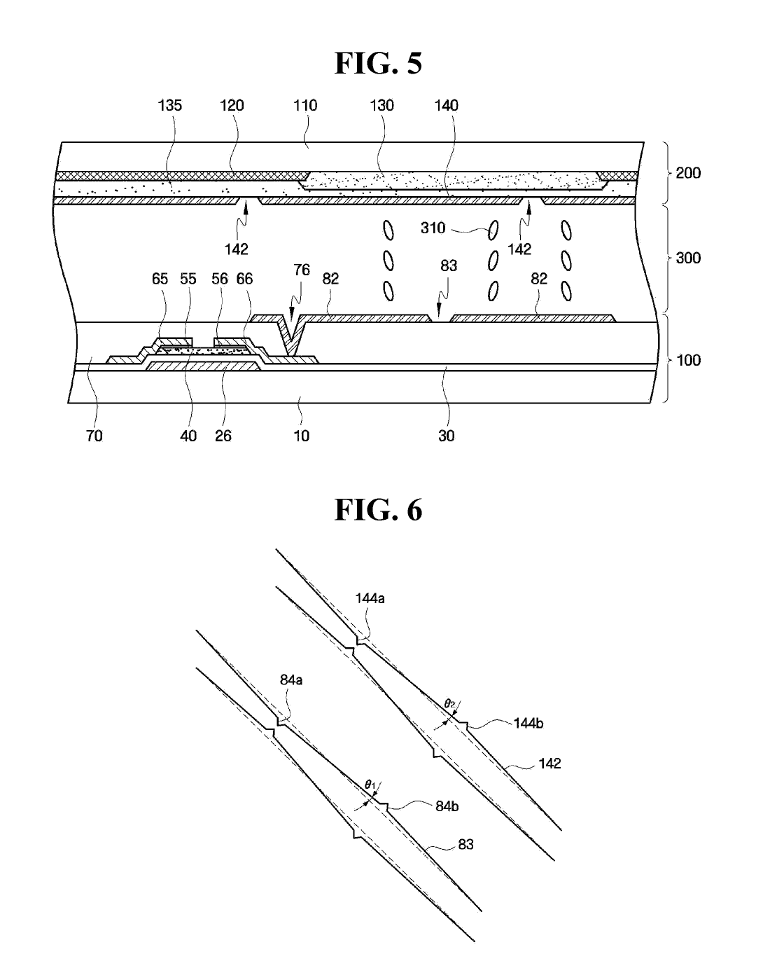

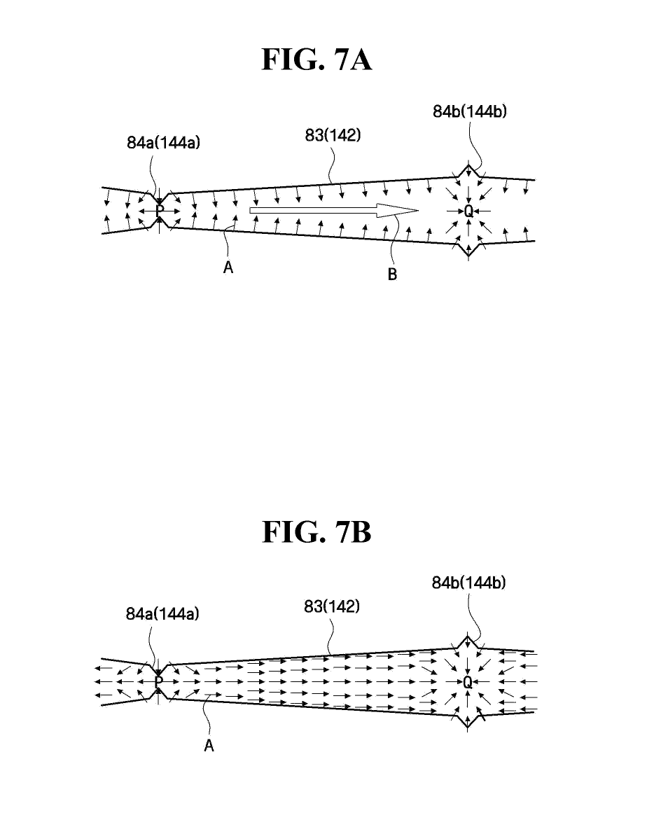

Hereinafter, a liquid crystal display according to an exemplary embodiment of the present invention will be described with reference to FIG. 1, FIG. 2, FIG. 3, FIG. 4, FIG. 5, FIG. 6, FIG. 7A, and FIG. 7B.

First, a thin film transistor array panel used in a liquid crystal display according to an exemplary embodiment of the present invention will be described with reference to FIG. 1 and FIG. 2. FIG. 1 is a layout view of a thin film transistor array panel for a liquid crystal display according to an exemplary embodiment of the present invention, and FIG. 2 is a cross-sectional view of the thin film transistor array panel shown in FIG. 1 taken along line II-II′.

Gate lines 22 are formed on an insulation substrate 10 in a first direction, for example, in a lateral direction, and gate electrodes 26 protrude from each gate line 22. The gate lines 22 and the gate electrodes 26 are referred to as gate wires.

In addition, storage wires 28 are formed on the insulation substrate 10 and extend substantially parallel to the gate lines 22 in the lateral direction. The storage wires 28 overlap pixel electrodes 82 in pixels. According to the exemplary embodiment shown in FIG. 1, a storage wire 28 is provided in the middle of each pixel. However, the present invention is not limited thereto and the shape and arrangement of each storage wire 28 may be modified in various ways to provide a predetermined storage capacitance.

Each of the gate wires 22 and 26 and storage wires 28 may be made of an aluminum-based metal, such as aluminum (Al) or an aluminum alloy, a silver-based metal, such as silver (Ag) or a silver alloy, a copper-based metal, such as copper (Cu) or a copper alloy, a molybdenum-based metal, such as molybdenum (Mo) or a molybdenum alloy, chromium (Cr), titanium (Ti), or tantalum (Ta). In addition, each of the gate wires 22 and 26 and storage wire 28 may have a multilayer structure that includes two conductive films (not shown) having different physical properties. One conductive film of the two conductive films may be made of a metal having low resistivity, for example, an aluminum-based metal, a silver-based metal, or a copper-based metal, to reduce signal delay or voltage drop in each of the gate wires 22 and 26 and storage wires 28. The other conductive film may be made of made of a material having excellent contact characteristics with respect to indium tin oxide (ITO) and indium zinc oxide (IZO), for example, a molybdenum-based metal, chromium, titanium, or tantalum. For example, a multilayer structure may include a chromium lower film and an aluminum upper film or an aluminum lower film and a molybdenum upper film. However, each of the gate wires 22 and 26 and storage wires 28 may also be made of various metallic materials or conductors other than the above metallic materials.

A gate insulating film 30, which may be made of silicon nitride (SiNx) or silicon oxide, is formed on the gate wires 22 and 26 and storage wires 28.

A semiconductor layer 40 made of hydrogenated amorphous silicon or polysilicon is formed on the gate insulating film 30. The semiconductor layer 40 may have various shapes, such as an island shape or a stripe shape. For example, as shown in FIG. 1, the semiconductor layer 40 may be formed on the gate electrodes 26 to have an island shape. Further, when a semiconductor layer according to another exemplary embodiment of the present invention is formed in a stripe shape, the semiconductor layer may be provided below the data lines 62 and may extend to the upper portion of the gate electrodes 26.

Ohmic contact layers 55 and 56 are formed on the semiconductor layer 40 and may be made of silicide or n+ hydrogenated amorphous silicon in which n-type impurities are doped at high concentration. Each of the ohmic contact layers 55 and 56 may have various shapes, such as an island shape or stripe shape. For example, as shown in FIG. 2, when each of the ohmic contact layers 55 and 56 is formed in an island shape, the ohmic contact layers 55 and 56 may be provided below drain electrodes 66 and source electrodes 65. In addition, when ohmic contact layers according to another exemplary embodiment of the present invention are formed in a stripe shape, the ohmic contact layers may extend to the lower portion of each data line 62.

The data lines 62 and drain electrodes 66 are formed on the ohmic contact layers 55 and 56 and gate insulating film 30. The data lines 62 extend in a second direction, for example, in a vertical direction, and cross the gate lines 22 so as to define pixels. Each source electrode 65 protrudes from the data line 62 to the upper portion of the semiconductor layer 40 in a branch shape. The drain electrode 66 is separated from the source electrode 65, and is provided above the semiconductor layer 40 so as to face the source electrode 65 with the gate electrode 26 there between. The drain electrode 66 includes a bar-shaped pattern provided above the semiconductor layer 40 and an extension pattern. The extension pattern extends from the bar-shaped pattern so as to have a wide area and overlaps the contact holes 76.

The data line 62, the source electrode 65, and the drain electrode 66 are referred to as data wires.

Each of the data wires 62, 65, and 66 may be made of a refractory metal, such as molybdenum, chromium, tantalum, or titanium, or an alloy thereof. Further, each of them may have a multilayer structure in which an upper film (not shown) made of a low-resistance material is formed on a lower film (not shown) made of a refractory metal or the like. For example, the multilayer structure may include a chromium lower film and an aluminum upper film or an aluminum lower film and a molybdenum upper film, as discussed above. Alternatively, the multilayer structure may be a three-layer structure including a molybdenum film, an aluminum film, and a molybdenum film.

At least a part of the source electrode 65 overlaps the semiconductor layer 40. Further, the drain electrode 66 faces the source electrode 65 with the gate electrode 26 there between, and at least a part of the drain electrode 66 overlaps the semiconductor layer 40. In this case, the ohmic contact layers 55 and 56 are interposed between the semiconductor layer 40 and the source electrode 65 and between the semiconductor layer 40 and the drain electrode 66, respectively, to reduce the contact resistance there between.

A passivation film 70 formed of an insulating film is formed on the data line 62, the drain electrode 66, and the exposed semiconductor layer 40. The passivation film 70 may be made of an inorganic material such as silicon nitride or silicon oxide, an organic material that has a good planarizing characteristic and photosensitivity, or an insulating material having a low dielectric constant, such as a-Si:C:O or a-Si:O:F, that is formed by plasma enhanced chemical vapor deposition (PECVD). In addition, the passivation layer 70 may have a dual-layer structure, which includes a lower inorganic layer and an upper organic layer, to improve characteristics of the organic film and to protect the exposed semiconductor layer 40.

The drain electrodes 66 are exposed through contact holes 76 formed in the passivation film 70.

The pixel electrodes 82, which are connected to the drain electrodes 66 through the contact holes 76, are formed on the passivation film 70. That is, the pixel electrodes 82 are connected to the drain electrodes 66 through the contact holes 76 and data voltages are applied to the pixel electrodes 82 from the drain electrodes 66. Each pixel electrode 82 may be formed of a transparent electric conductor such as ITO or IZO, or a reflective electric conductor such as aluminum. An alignment film (not shown) capable of aligning the liquid crystal molecules may be formed on the pixel electrodes 82 and the passivation film 70.

Each pixel electrode 82 is divided into a plurality of regions by gaps 83 formed by cutout patterns. In this case, each gap 83 includes a lateral part and inclined parts. The lateral part extends in the lateral direction so as to divide the pixel electrode 82 into two portions, that is, upper and lower portions. The inclined parts are formed in the upper and lower portions of the pixel electrode 82 so as to extend in an inclined direction. The inclined parts formed in the upper and lower portions are orthogonal to each other to uniformly disperse the lateral electric field in four directions. Each inclined part includes a portion, which is inclined with respect to the gate line 22 by substantially 45°, and a portion, which is inclined with respect to the gate line 22 by substantially −45°. Each gap 83 may be substantially symmetric with respect to a bisector that halves the pixel region. For example, as shown in FIG. 1, the inclined parts of the gap 83 inclined with respect to the gate line 22 by substantially 45° are formed in the pixel electrode 82 positioned above the center of the pixel, and the inclined parts of the gap 83 inclined with respect to the gate line 22 by substantially −45° are formed in the pixel electrode 82 positioned below the center of the pixel. However, the present invention is not limited thereto and the shapes and arrangement of the inclined parts of the gap 83 may be modified in various ways as long as the inclined parts of the gap 83 are inclined with respect to the gate line 22 by substantially 45° or −45°. In addition, according to a modification of the present invention, if protrusions, instead of gaps, are formed at positions corresponding to the gaps 83, it is possible to obtain the same effects as described above. The gaps 83 or protrusions are referred to as domain dividers. Hereinafter, for convenience of description, the present invention will be described using gaps 83 as the domain dividers.

Notches 84a and 84b for preventing display irregularities or residual images from occurring are formed in the gaps 83, particularly, in the inclined parts. The notches 84a and 84b may be composed of concave notches 84a and convex notches 84b that are alternately arranged. Further, it is preferable that the width of each gap 83 increases or decreases in a predetermined direction in order to more effectively prevent the display irregularities or residual images from occurring in the gaps 83. This will be described in detail below.

The gaps 83 of the pixel electrode 82 and the gaps (refer to reference numeral 142 in FIG. 3) of a common electrode divide the display region of the pixel electrode 82 into a plurality of domains along directions in which directors of liquid crystal molecules included in the liquid crystal layer are arrayed when applying an electric field. In this case, the domains are regions formed of liquid crystal molecules having directors inclined in a specific direction due to the electric field between the pixel electrodes 82 and the common electrodes (refer to reference numeral 140 in FIG. 3). This will be described in detail below.

Hereinafter, a common electrode panel according to an exemplary embodiment of the present invention and a liquid crystal display including the common electrode panel will be described with reference to FIG. 3, FIG. 4, and FIG. 5. FIG. 3 is a layout view of a common electrode panel for a liquid crystal display according to the exemplary embodiment of the present invention. FIG. 4 is a layout view of a liquid crystal display that includes the thin film transistor array panel shown in FIG. 1 and the common electrode panel shown in FIG. 3. FIG. 5 is a cross-sectional view of the liquid crystal display shown in FIG. 4 taken along line V-V′.

Referring to FIG. 3, FIG. 4, and FIG. 5, black matrices 120, which prevent light from leaking and define pixel regions, are formed on an insulation substrate 110, which may be made of a transparent insulating material such as glass. Each black matrix 120 may be formed of a metal or metal oxide, such as chromium or chromium oxide, or an organic black resist.

Further, red, green, and blue color filters 130 are sequentially arranged in the pixel region between the black matrices 120.

An overcoat layer 135 for removing the difference in height between the color filters may be formed on the color filters 130.

The common electrodes 140, which may be made of a transparent conductive material, such as ITO or IZO, are formed on the overcoat layer 135. An alignment film (not shown) for aligning liquid crystal molecules may be formed on the common electrodes 140. The common electrodes 140 may be individually formed in each pixel or they may by portions of an electrode that is substantially formed on the entire common electrode panel.

Each common electrode 140 is divided into a plurality of regions by gaps 142 formed by cutout patterns. Each gap 142 includes inclined parts and end parts. The inclined parts of the gaps 142 in the common electrode 140 and the inclined parts of the gaps 83 formed in the pixel electrode 82 are alternately arranged to be adjacent to each other. The end parts of the gaps 142 overlap the edges of the pixel electrodes 82 and may be composed of vertical end parts and lateral end parts. In addition, according to another modification of the present invention, if protrusions, instead of gaps, are formed at positions corresponding to the gaps 142, it may be possible to obtain the same effects as described above. The gaps 142 or protrusions are referred to as domain dividers. Hereinafter, for convenience of description, the present invention will be described using gaps 142 as the domain dividers.

Notches 144a and 144b for preventing display irregularities or residual images from occurring are formed in the gaps 142, particularly, in the inclined parts. The notches 144a and 144b may be composed of concave notches 144a and convex notches 144b that are alternately arranged to correspond to the concave notches 84a and convex notches 84b of the pixel electrodes 82. Further, each gap 142 may have a width that increases or decreases in a predetermined direction to more effectively prevent the display irregularities or residual images from occurring in the gaps 142. This will be described in detail below.

As shown in FIG. 4, the inclined parts of the gaps 83 formed in each pixel electrode 82 and the inclined parts of the gaps 142 formed in the common electrode 140 may be arranged in the same direction. In addition, the inclined parts of the gaps 83 formed in each pixel electrode 82 alternate with the inclined parts of the gaps 142 formed in the common electrode 140 and form a lateral electric field.

As shown in FIG. 5, a thin film transistor array panel 100 is aligned with and coupled to a common electrode panel 200. A liquid crystal layer 300 is perpendicularly aligned between the thin film transistor array panel 100 and common electrode panel 200. As a result, it may be possible to obtain the basic structure of the liquid crystal display according to the embodiment of the present invention.

Liquid crystal molecules 310 included in the liquid crystal layer 300 are aligned so that directors of the liquid crystal molecules are perpendicular to the thin film transistor array panel 100 and common electrode panel 200 when the electric field is not applied between the pixel electrodes 82 and the common electrodes 140. Further, the liquid crystal molecules 310 have negative dielectric anisotropy. The thin film transistor array panel 100 and common electrode panel 200 are aligned with each other so that the pixel electrodes 82 correspond to and overlap the color filters 130 with high accuracy. As a result, each pixel is divided into a plurality of domains by the gaps 142 of each common electrode 140 and the gaps 83 of each pixel electrode 82.

The liquid crystal display includes components, such as polarizers and backlights, in addition to the above-mentioned basic structure. For example, polarizers may be provided on both sides of the basic structure so that one of the axes of the polarizers is parallel to the gate lines and the other of axis of the polarizers is orthogonal to the gate lines.

When an electric field is applied between the thin film transistor array panel 100 and common electrode panel 200, an electric field perpendicular to the panels 100 and 200 is formed in almost all of the regions. However, a lateral electric field is generated near the gaps 83 of each pixel electrode 82 and the gaps 142 of each common electrode 140. The lateral electric field allows the liquid crystal molecules 310 to be aligned in each domain.

The liquid crystal molecules 310 according to this embodiment have negative dielectric anisotropy. Accordingly, when an electric field is applied to the liquid crystal molecules 310, the liquid crystal molecules 310 in each domain are inclined to be orthogonal to the gaps 83 or 142 that divide the domain. For this reason, the liquid crystal molecules 310 are inclined in different directions on opposite sides of the gaps 83 or gaps 142, and the inclined parts of the gaps 83 and 142 are symmetric with respect to the middle of each pixel. As a result, the liquid crystal molecules 310 are inclined in four directions with respect to the gate line 22 by substantially 45° or −45°. Since the liquid crystal molecules 310 are inclined in four directions, optical characteristics may be compensated by each other and the viewing angle may be increased.

Hereinafter, the shapes and operation of gaps in the liquid crystal display according to an exemplary embodiment of the present invention will be described in detail with reference to FIG. 4, FIG. 6, FIG. 7A, and FIG. 7B. FIG. 6 is an enlarged layout view of gaps of the pixel electrode and the common electrode shown in FIG. 4. FIG. 7A is a view showing the initial arrangement of liquid crystal molecules provided at the gaps after an electric field is applied between the pixel electrode and the common electrode. FIG. 7B is a view showing the final arrangement of liquid crystal molecules provided at the gaps after an electric field is applied between the pixel electrode and the common electrode.

First, as shown in FIG. 4 and FIG. 6, each gap 83 of the pixel electrodes 82 includes inclined parts inclined with respect to the gate line 22 by substantially 45° or −45°, and each gap 142 of the common electrodes 140 includes inclined parts inclined with respect to the gate line 22 by substantially 45° or −45°. The inclined parts of the gaps 83 and 142 are alternately arranged to be adjacent to each other.

Concave notches 84a and convex notches 84b are alternately arranged in the gaps 83 to prevent display irregularities or residual images from occurring in the liquid crystal display. In addition, concave notches 144a and convex notches 144b are alternately arranged in the gaps 142 to prevent display irregularities or residual images from occurring in the liquid crystal display. Each of the notches 84a, 84b, 144a, and 144b of this embodiment has a triangular shape. However, the present invention is not limited thereto and each of the notches may be modified to have a semicircular shape or a polygonal shape, such as a quadrangle or trapezoid. The orientations of the liquid crystal molecules provided at the domain boundaries corresponding to the gaps 83 and 142 are determined by the notches 84a, 84b, 144a, and 144b. As noted above, the pixel electrodes 82 and common electrode 140 may have protrusions instead of gaps 83 and 142. In this case, notches 84a, 84b, 144a, and 144b may be formed in the protrusions, which are made of an inorganic material or organic material, to have a concave or convex shape, instead of in the gaps 83 and 142.

The initial and final arrangement of the liquid crystal molecules provided at the gaps after an electric field is applied between the pixel electrodes and common electrodes will be specifically described below with reference to FIG. 7A and FIG. 7B. When singular points P and Q are intentionally formed in the gaps 83 and 142 by the notches 84a, 84b, 144a, and 144b, the elastic energy of the liquid crystal molecules provided near the singular points P and Q is accumulated and the arrangement directions A of the heads of the liquid crystal molecules may be controlled. For example, singular points P having negative polarities are formed in the regions in which the concave notches 84a and 144a are formed. The arrangement directions A of the heads of the liquid crystal molecules partially converge into and partially diverge from singular points P having negative polarities. Further, singular points Q having positive polarities are formed in the regions in which the convex notches 84b and 144b are formed. The arrangement directions A of the heads of the liquid crystal molecules converge into the singular points Q having positive polarities. Accordingly, when the concave notches 84a and 144a and the convex notches 84b and 144b are alternately arranged in the regions, the arrangement directions A of the head of the liquid crystal molecules can be controlled so that the heads of the liquid crystal molecules provided at the domain boundaries are oriented from the singular points P having negative polarities toward the singular points Q having positive polarities. The orientations of the liquid crystal molecules provided in the domain boundaries, that is, the gaps 83 and 142, may be controlled by the notches 84a, 84b, 144a, and 144b. For this reason, it may be possible to prevent the arrangement of the liquid crystal molecules from being distorted from the domain boundaries toward the inside of the domains when applying the driving voltages.

Accordingly, it may be possible to arrange the liquid crystal molecules, which are provided at the domain boundaries, stably and regularly due to the notches 84a, 84b, 144a, and 144b. As a result, it may be possible to prevent the occurrence of display irregularities or residual images at the domain boundaries. In addition, the liquid crystal molecules provided at the domain boundaries may be stably arranged due to the notches 84a, 84b, 144a, and 144b. For this reason, it may be possible to reduce the width of each of the inclined parts in the gaps 83 and 142 and as a result, it may be possible to improve brightness.

Each gap 83 and 142 may have a width that increases or decreases in a predetermined direction to more effectively prevent display irregularities and residual images from occurring at the domain boundaries. For example, the width of each gap 83 and 142 may increase as the gap approaches the convex notches 84b and 144b from the concave notches 84a and 144a. In this case, arrangement driving forces (in directions B), which allow the heads of the liquid crystal molecules to be oriented from the singular points P having negative polarities formed in the concave notches 84a and 144a toward the singular points Q having positive polarities formed in the convex notches 84b and 144b, may be further improved. Therefore, the liquid crystal molecules provided in the gaps 83 and 142 may be arranged in predetermined directions more quickly.

In addition, the improved arrangement driving forces may prevent one or more singular points from forming between the concave notches 84a and 144a and the convex notches 84b and 144b. When the arrangement driving forces are small, two singular points may be commonly formed between the concave notches 84a and 144a and the convex notches 84b and 144b. When singular points form in regions between notches, rather than in regions in which the notches 84a, 84b, 144a, and 144b are formed, the positions of the singular points formed between the notches change at every application of the driving voltages, which changes the lateral view. As a result, humans see a difference in brightness, which causes residual images to suddenly appear. According to the present invention, the width of each gap 83 and 142 increases or decreases in a predetermined direction in a predetermined range, which may make it possible to prevent singular points from forming between the notches 84a, 84b, 144a, and 144b.

The side portions of the gaps 83 and 142 may be inclined at predetermined angles between the concave notches 84a and 144a and the convex notches 84b and 144b in the longitudinal directions of the gaps 83 and 142. For example, the side portions of the gaps 83 and 142 may be inclined at angles θ1 and θ2, which are in the range of about 0° to 15°, in the longitudinal directions of the gaps 83 and 142. The side portions of the gaps 83 and 142 may be inclined at angles of 0° or more to obtain the arrangement driving forces of the liquid crystal molecules. Further, when the side portions of the gaps 83 and 142 are inclined at angles of 15° or more, it may be difficult to control the movements of the liquid crystal molecules adjacent to the gaps 83 and 142 in the domains.

In addition, the concave notch 84a formed in each gap 83 may correspond to and be disposed adjacent to the concave notch 144a formed in each gap 142, and the convex notch 84b formed in each gap 83 may correspond to and be disposed adjacent to the convex notch 144b formed in each gap 142, in order to incline the liquid crystal molecules in the domains with respect to the gate line 22 by substantially 45° or −45°.

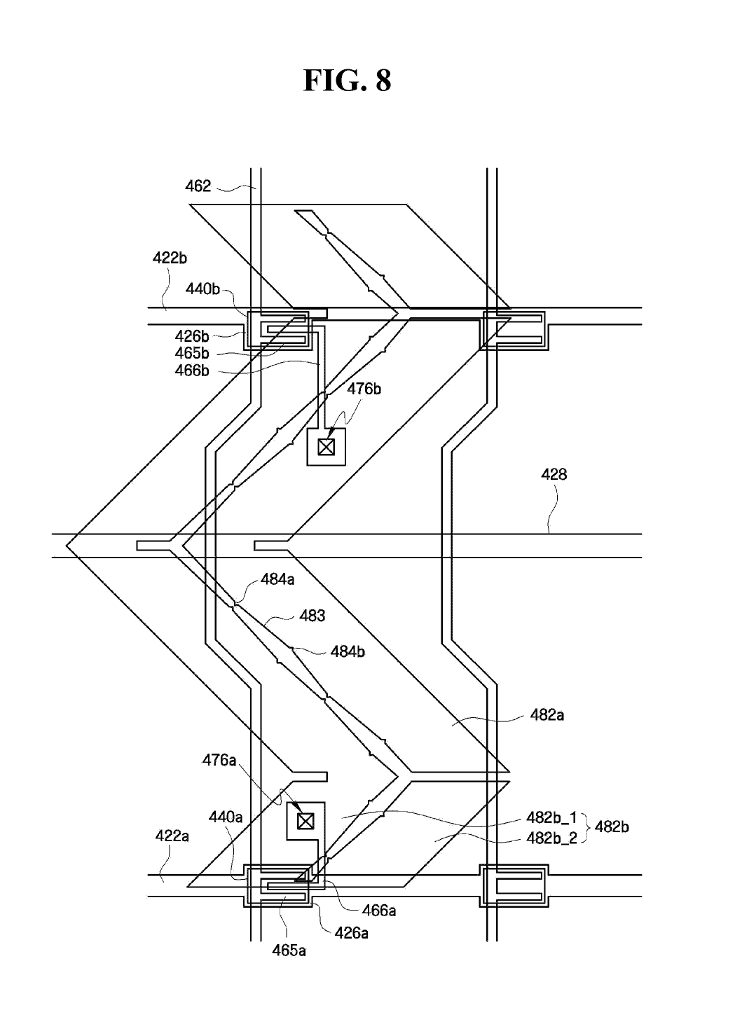

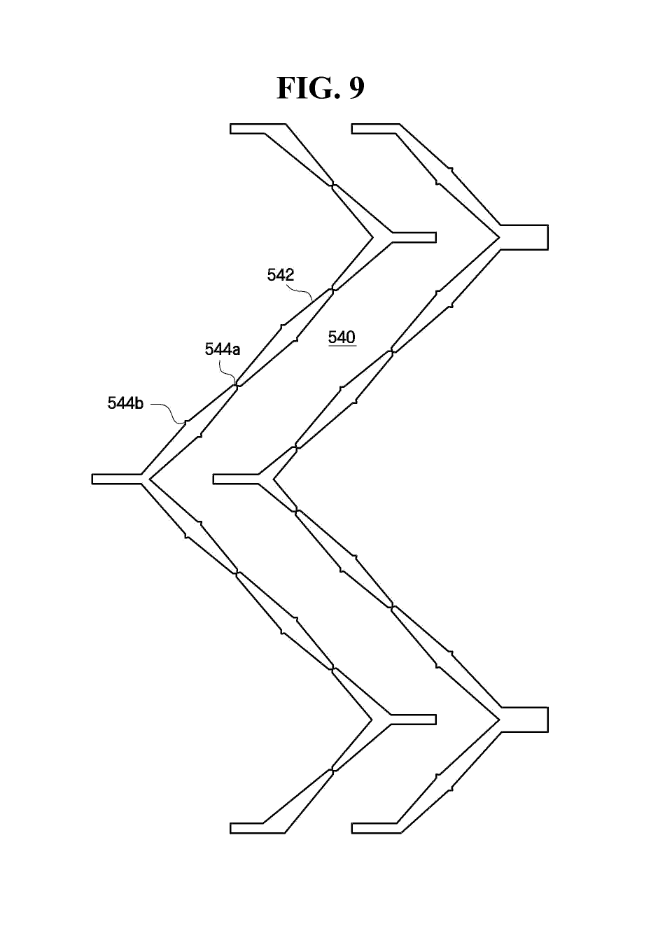

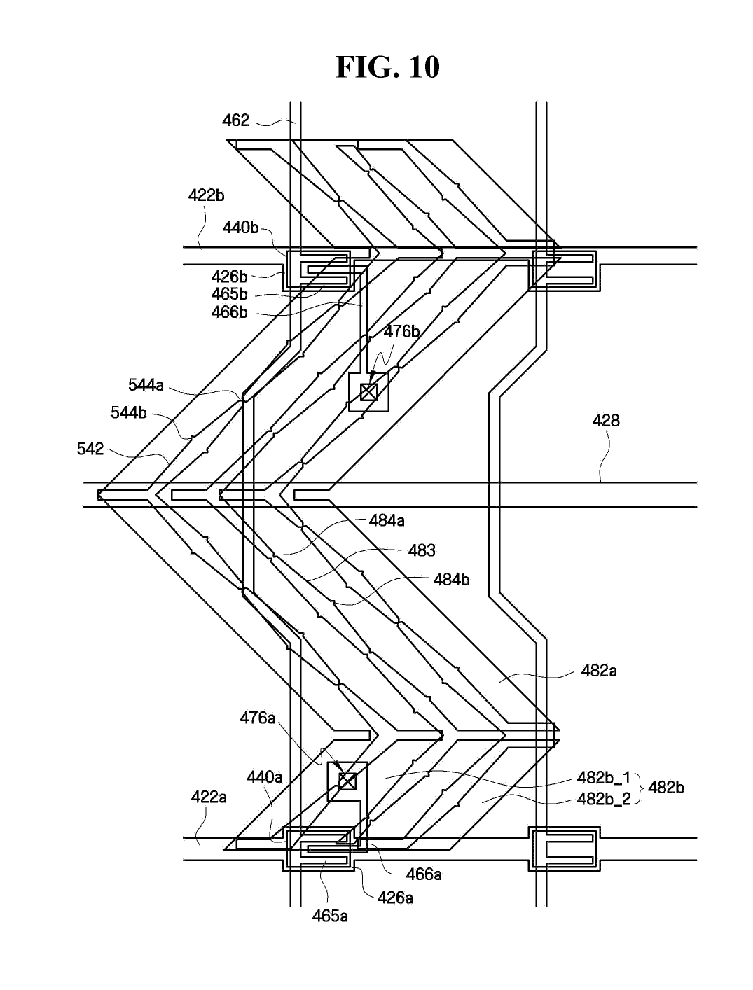

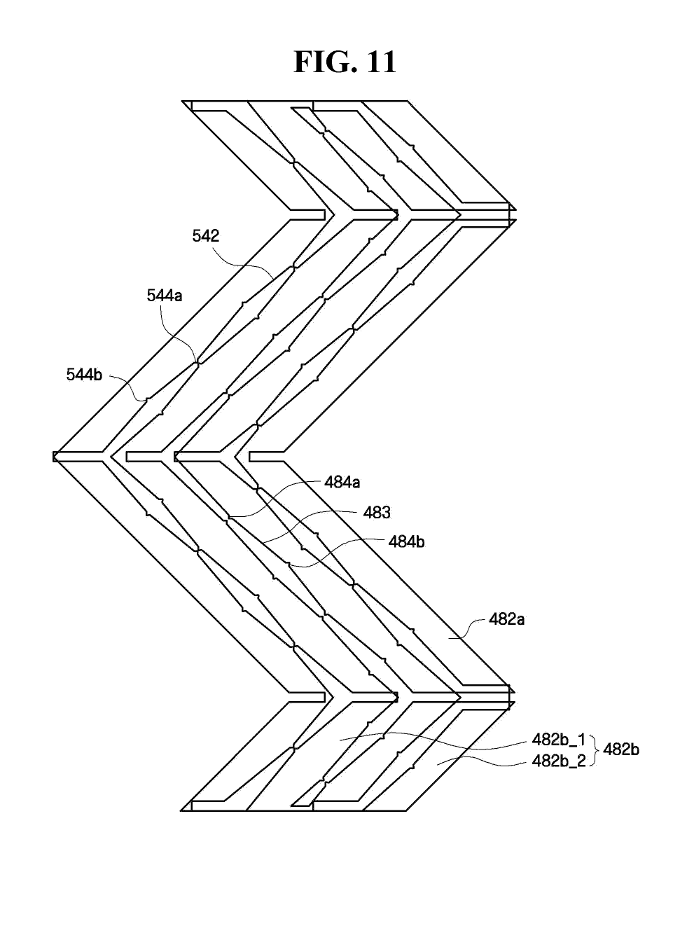

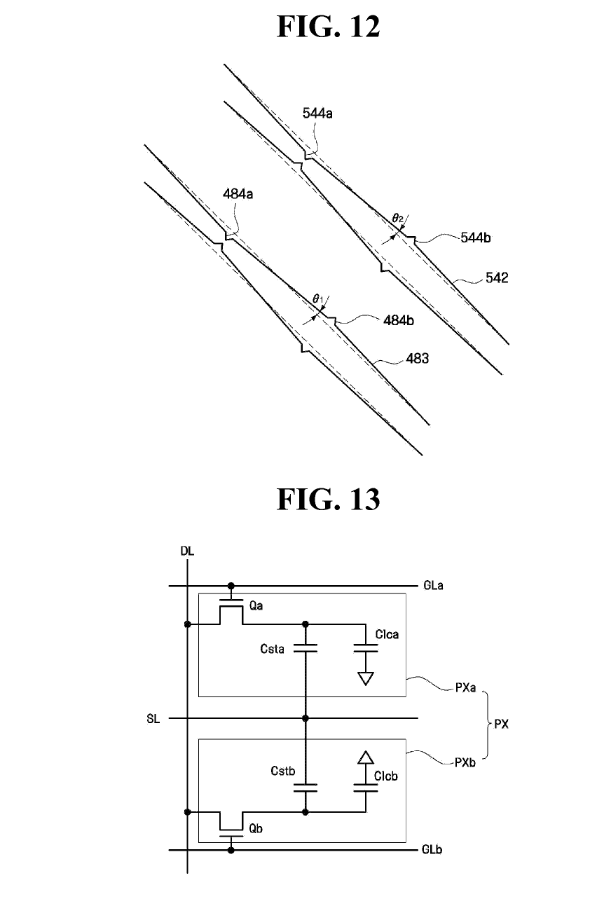

Hereinafter, a liquid crystal display according to another exemplary embodiment of the present invention will be described with reference to FIG. 8, FIG. 9, FIG. 10, FIG. 11, FIG. 12, and FIG. 13.

FIG. 8 is a layout view of a thin film transistor array panel for a liquid crystal display according to another exemplary embodiment of the present invention, and FIG. 9 is a layout view of a common electrode panel for the liquid crystal display according to another exemplary embodiment of the present invention. FIG. 10 is a layout view of a liquid crystal display that includes the thin film transistor array panel shown in FIG. 8 and the common electrode panel shown in FIG. 9.

As shown in FIG. 8, FIG. 9, and FIG. 10, a liquid crystal display according to another exemplary embodiment of the present invention includes a thin film transistor array panel, a common electrode panel facing the thin film transistor array panel, and a liquid crystal layer interposed between the panels.

First, a thin film transistor array panel for a liquid crystal display according to another exemplary embodiment of the present invention will be described in more detail with reference to FIG. 8.

A first panel uses a first insulation substrate (not shown), which may be made of transparent glass or plastic, as a base substrate. A first gate line 422a and a second gate line 422b, which extend in a first direction, that is, in a lateral direction, are formed on the first insulation substrate. The first gate line 422a is positioned at the boundary portion of a pixel, and the second gate line 422b extends parallel to the first gate line 422a and traverses the upper portion of the pixel.

The first gate line 422a and second gate line 422b partially protrude in a predetermined region to form a first gate electrode 426a and a second gate electrode 426b, respectively. The shapes of the first gate electrode 426a and second gate electrode 426b may be modified in various ways.

A storage wire 428 is formed on the same layer as the first and second gate lines 422a and 422b, which are formed on the first insulation substrate. The storage wire 428 may be arranged in various ways. For example, as shown in FIG. 8, the storage wire 428 may traverse the pixel in the lateral direction to divide the pixel into two portions, that is, upper and lower portions. The storage wire 428 overlaps a first sub-pixel electrode 482a and second sub-pixel electrode 482b that will be described below.

The first gate line 422a, second gate line 422b, first gate electrode 426a, second gate electrode 426b, and storage wire 428 may be made of substantially the same material as the gate wires 22 and 26 shown in FIG. 1.

A gate insulating film (not shown), which may be made of silicon nitride or silicon oxide, may be laminated on the first gate line 422a, second gate line 422b, and storage wire 428. A first semiconductor layer 440a and a second semiconductor layer 440b, which may be made of hydrogenated amorphous silicon or polysilicon, are formed on the gate insulating film. The first semiconductor layer 440a overlaps the first gate electrode 426a, and the second semiconductor layer 440b overlaps the second gate electrode 426b.

Data wires 462, 465a, 466a, 465b, and 466b are formed on the first and second semiconductor layers 440a and 440b or the gate insulating film. The data wires 462, 465a, 466a, 465b, and 466b include a data line 462, a first source electrode 465a, a first drain electrode 466a, a second source electrode 465b, and a second drain electrode 466b. The data line 462 extends in a second direction, for example, in a vertical direction. The first source electrode 465a protrudes from the data line 462 toward the first gate electrode 426a, and the first drain electrode 466a is separated from the first source electrode 465a and faces the first source electrode 465a. The second source electrode 465b protrudes from the data line 462 toward the second gate electrode 426b, and the second drain electrode 466b is separated from the second source electrode 465b and faces the second source electrode 465b. The data line 462 may linearly extend in the vertical direction. However, as shown in FIG. 8, the data line 462 may zigzag along the pixel electrode in the middle region of each pixel. At least parts of the first source electrode 465a and first drain electrode 466a overlap the first gate electrode 426a and first semiconductor layer 440a, and at least parts of the second source electrode 465b and second drain electrode 466b overlap the second gate electrode 426b and second semiconductor layer 440b.

The data wires 462, 465a, 466a, 465b, and 466b may be made of substantially the same material as the data wires 62, 65, and 66 shown in FIG. 1.

The first gate electrode 426a, first source electrode 465a, and first drain electrode 466a form a first thin film transistor that includes the first semiconductor layer 440a as a channel part. Further, the second gate electrode 426b, second source electrode 465b, and second drain electrode 466b form a second thin film transistor that includes the second semiconductor layer 440b as a channel part. Ohmic contact layers (not shown) made of n+ hydrogenated amorphous silicon doped at high concentration may be interposed between the first semiconductor layer 440a and the first source electrode 465a formed on the first semiconductor layer 440a, between the first semiconductor layer 440a and the first drain electrode 466a, between the second semiconductor layer 440b and the second source electrode 465b formed on the second semiconductor layer 440b, and between the second semiconductor layer 440b and the second drain electrode 466b, respectively. As a result, it may be possible to reduce the contact resistance there between.

A passivation film (not shown) may be formed on the data wires 462, 465a, 466a, 465b, and 466b. The passivation film may be made of substantially the same material as the passivation film 70 shown in FIG. 2. At least parts of the first drain electrode 466a and second drain electrode 466b are exposed through contact holes 476a and 476b formed in the passivation film.

The pixel electrodes 482a and 482b may be made of a transparent conductive material such as ITO or IZO and are formed on the passivation film.

The pixel electrodes 482a and 482b, as a whole, form a zigzag shape in which both sides thereof are inclined with respect to the first gate line 422a and the second gate line 422b. Both sides of the pixel electrodes 482a and 482b may have substantially the same shape and extend parallel to each other. The upper and lower ends of the pixel electrodes 482a and 482b may be parallel to the first gate electrode 426a and second gate electrode 426b.

Since both sides of the pixel electrodes 482a and 482b zigzag, both sides of the pixel electrodes 482a and 482b include at least one bent portion. In FIG. 8, the pixel electrodes 482a and 482b include three bent portions. Referring to FIG. 8, both sides of the pixel electrodes 482a and 482b extend from above and are inclined with respect to the first gate line 422a and second gate line 422b at negative angles, for example, at angles of −45°. At a first bent portion, both sides of the pixel electrodes 482a and 482b are inclined with respect to the first gate line 422a and second gate line 422b at positive angles, for example, at angles of 45°. The second gate line 422b traverses the first bent portion. Both sides of the pixel electrodes 482a and 482b, which are bent at the first bent portion, are reversely bent and again inclined at negative angles at a second bent portion, and are reversely bent and again inclined at positive angles at a third bent portion. In this case, the second bent portion is positioned in the middle of the pixel electrodes 482a and 482b in the vertical direction. The upper and lower portions of the pixel electrodes 482a and 482b may be symmetric about the second bent portion.

The pixel electrodes include a first sub-pixel electrode 482a and a second sub-pixel electrode 482b. The second sub-pixel electrode 482b is connected to the first drain electrode 466a through the contact hole 476a and is driven by the first thin film transistor. The first sub-pixel electrode 482a is connected to the second drain electrode 466b through the contact hole 476b and is driven by the second thin film transistor. A pair of gray scale voltage groups, which have different gamma curves obtained from the same image information, is applied to the first and second sub-pixel electrodes 482a and 482b. A gamma curve for one pixel is obtained from the composition of the different gamma curves. If the composition gamma curve at the front becomes similar to the reference gamma curve at the front and the composition gamma curve at the side becomes most similar to the reference gamma curve at the front, it may be possible to improve side visibility.

Although the pixel electrodes 482a and 482b include three bent portions as described above, the number of bent portions according to the present invention is not limited to three. The pixel electrodes 482a and 482b include the first sub-pixel electrode 482a and the second sub-pixel electrode 482b that surrounds the first sub-pixel electrode 482a except on one side of the first sub-pixel electrode 482a. The first sub-pixel electrode 482a is insulated from the second sub-pixel electrode 482b by the gaps 483 that extend in a vertical direction and have a substantially zigzag shape. Specifically, each gap 483 includes parts (hereinafter, referred to as inclined parts) that are inclined with respect to the first and second gate lines 422a and 422b at angles of about 45° or −45°, and parts (hereinafter, referred to as lateral parts) that extend in a lateral direction at first and third bent portions to separate the first sub-pixel electrode 482a from the second sub-pixel electrode 482b in the vertical direction. In addition, according to another modification of the present invention, if protrusions, instead of gaps, are formed at positions corresponding to the gaps 483, it may be possible to obtain the same effects as described above. The gaps 483 or protrusions are referred to as domain dividers. Hereinafter, for convenience of description, the present invention will be described using gaps 483 as the domain dividers.

Notches 484a and 484b for preventing display irregularities or residual images from occurring are formed in the inclined parts of the gaps 483, as described in the above-mentioned exemplary embodiments. The notches 484a and 484b may be composed of concave notches 484a and convex notches 484b that are alternately arranged.

The first sub-pixel electrode 482a may be substantially V shaped. The second sub-pixel electrode 482b includes a side electrode 482b_1 disposed adjacent to the side of the first sub-pixel electrode 482a and formed in a zigzag shape having three bent portions, and a pair of upper and lower electrodes 482b_2 disposed on the upper and lower sides of the first sub-pixel electrode 482a and on the side of the side electrode 482b_1. The side electrode 482b_1 and the upper and lower electrodes 482b_2, which form the second sub-pixel electrode 482b, are connected to each other by connecting portions. Accordingly, the second sub-pixel electrode 482b surrounds the first sub-pixel electrode 482a except on one side of the first sub-pixel electrode 482a.

An alignment film (not shown) may be further formed on the first and second sub-pixel electrodes 482a and 482b. The alignment film may be, for example, a vertical alignment film that allows the major axes of the liquid crystal molecules to initially be aligned in a substantially vertical direction.

Hereinafter, a common electrode panel according to another exemplary embodiment of the present invention and a liquid crystal display including the common electrode panel will be described with reference to FIG. 9 and FIG. 10.

Referring to FIG. 9 and FIG. 10, black matrices (not shown), which prevent light from leaking and define pixel regions, may be formed on a second insulation substrate (not shown), which may be made of a transparent glass or plastic. The black matrices overlap the first gate line 422a and data line 462, and may be formed of a metal or metal oxide, such as chromium or chromium oxide, or an organic black resist. Red, green, and blue color filters (not shown) may be sequentially arranged in the pixel region surrounded by the black matrices. The color filters may be aligned to overlap the first and second sub-pixel electrodes 482a and 482b.

An overcoat layer (not shown) for removing the height difference between the color filters and the black matrices may be formed on the black matrices and color filters.

Common electrodes 540, which may be made of a transparent conductive material, such as ITO or IZO, are formed on the overcoat layer. Similar to the previous exemplary embodiment, the common electrodes 540 may be formed on the entire surface of the common electrode panel, regardless of the pixels, or they may be individually formed in the pixels. An alignment film (not shown) for aligning liquid crystal molecules may be formed on the common electrodes 540. The alignment film may be a vertical alignment film like in the thin film transistor array panel.

In this case, each common electrode 540 faces the pixel electrodes 482a and 482b, and is divided into a plurality of regions by gaps 542 formed by cutout patterns. Each gap 542 includes inclined parts and lateral parts. The inclined parts of the gaps 542 formed in the common electrodes 540 and the inclined parts of the gaps 483 formed in the pixel electrodes 482a and 482b are alternately arranged to be adjacent to each other. The lateral parts of the gaps 542 are disposed on the same line as the lateral parts of the gaps 483 formed in the pixel electrodes 482a and 482b. In addition, according to another modification of the present invention, if protrusions, instead of gaps, are formed at positions corresponding to the gaps 542, it may be possible to obtain the same effects as described above. The gaps 542 or protrusions are referred to as domain dividers. Hereinafter, for convenience of description, the present invention will be described using gaps 542 as the domain dividers.

The gaps 542 may be inclined with respect to the gate lines 422a and 422b by about 45° or −45°. Each gap 542 may have a bent shape corresponding to the shape of each pixel. That is, the gaps 542 may be disposed in the area between both sides of the first sub-pixel electrode 482a, in the area between both sides of the side electrode 482b_1, and in the area between both sides of the upper and lower electrodes 482b_2. Although the gaps 542 may be composed of cutout patterns formed in the common electrodes 540, the present invention is not limited thereto. If protrusions are formed at positions corresponding to the gaps 542, it may be possible to obtain the same effects as described above.

Each pixel is divided into a plurality of domains by the gaps 542 of each common electrode 540 and the gaps 483 of each pixel electrode 482a and 482b. In this case, the domain of each pixel is divided into left and right portions by the gaps 542 and 483, and is divided into upper and lower portions by the bent portions of the pixel electrodes 482a and 482b. That is, each pixel is divided into four domains along directions in which the directors of the liquid crystal molecules included in the liquid crystal layer are arrayed when applying an electric field.

Notches 544a and 544b for preventing display irregularities or residual images from occurring are formed in the inclined parts of the gaps 542, as described in the above-mentioned exemplary embodiments. The notches 544a and 544b may include concave notches 544a and convex notches 544b that are alternately arranged.

A thin film transistor array panel having the structure described above is aligned with and coupled to a common electrode panel, and a liquid crystal layer is perpendicularly aligned between the thin film transistor array panel and common electrode panel. As a result, it may be possible to obtain a basic structure of the liquid crystal display according to the embodiment of the present invention. The liquid crystal display includes components, such as a polarizers and backlights, in addition to the above-mentioned basic structure. For example, polarizers may be provided on both sides of the basic structure so that the axis of one of the polarizers is parallel to the gate lines 422a and 422b and the axis of the other polarizer is orthogonal to the gate lines 422a and 422b.

When an electric field is applied between the thin film transistor array panel and common electrode panel, an electric field perpendicular to the panels is formed in almost all regions. However, a lateral electric field is generated near the gaps 483 of the pixel electrodes 482a and 482b and the gaps 542 of the common electrodes 540. The lateral electric field allows the liquid crystal molecules to be aligned in each of the domains.

The liquid crystal molecules, according to this embodiment, have negative dielectric anisotropy. Accordingly, when an electric field is applied to the liquid crystal molecules, the liquid crystal molecules in each domain are inclined to be orthogonal to the gaps 483 or 542 that define the domains. For this reason, the liquid crystal molecules are inclined in different directions on opposite sides of the gaps 483 or gaps 542, and the inclined parts of the gaps 483 and 542 are symmetric with respect to the middle of each pixel. As a result, the liquid crystal molecules are inclined in four directions, with respect to the gate lines 422a and 422b, by substantially 45° or −45°. Since the liquid crystal molecules are inclined in four directions, optical characteristics may be compensated by each other and the viewing angle may be increased.

Hereinafter, the shapes and operation of gaps in the liquid crystal display of FIG. 10 will be described in detail with reference to FIG. 10, FIG. 11, and FIG. 12. FIG. 11 is a layout view showing gaps of a pixel electrode and the common electrode shown in FIG. 10, and FIG. 12 is an enlarged layout view of the gaps of the pixel electrode and the common electrode shown in FIG. 11.

First, as shown in FIG. 10 and FIG. 11, each gap 483 of the pixel electrode 482 includes inclined parts inclined with respect to the gate lines 422a and 422b by substantially 45° or −45°, and each gap 542 of the common electrode 540 includes inclined parts inclined with respect to the gate lines 422a and 422b by substantially 45° or −45°. The inclined parts of the gaps 483 and 542 are alternately arranged to be adjacent to each other.

Concave notches 484a and convex notches 484b are alternately arranged in the gaps 483 to prevent display irregularities or residual images from occurring in the liquid crystal display. In addition, concave notches 544a and convex notches 544b are alternately arranged in the gaps 542 to prevent display irregularities or residual images from occurring in the liquid crystal display. Each of the notches 484a, 484b, 544a, and 544b of this embodiment has a triangular shape. However, the present invention is not limited thereto, and each of the notches may be modified to have a semicircular shape or a polygonal shape such as quadrangle or trapezoid. Each of the notches 484a, 484b, 544a, and 544b has substantially the same operation as each of the notches (refer to reference numerals 84a, 84b, 144a, and 144b in FIG. 4) of the above-mentioned exemplary embodiments.

Each gap 483 and 542 may have a width that increases or decreases in a predetermined direction in order to more effectively prevent display irregularities or residual images from occurring at the domain boundaries. For example, the width of each gap 483 and 542 may increase as the gap approaches the convex notches 484b and 544b from the concave notches 484a and 544a. Therefore, the liquid crystal molecules provided in the gaps 483 and 542 may be arranged in predetermined directions more quickly.

In addition, the side portions of the gaps 483 and 542 are inclined at predetermined angles between the concave notches 484a and 544a and the convex notches 484b and 544b in the longitudinal directions of the gaps 483 and 542, to prevent one or more singular points from forming between the concave notches 484a and 544a and the convex notches 484b and 544b. For example, like in the above-mentioned exemplary embodiments, the side portions of the gaps 483 and 542 may be inclined at angles θ1 and θ2, which may be in the range of about 0 to 15°, in the longitudinal directions of the gaps 483 and 542.

In addition, the concave notch 484a formed in each gap 483 may correspond to and be disposed adjacent to the concave notch 544a formed in each gap 542, and the convex notch 484b formed in each gap 483 may correspond to and be disposed adjacent to the convex notch 544b formed in each gap 542, in order to incline the liquid crystal molecules in the domains, with respect to the gate lines 422a and 422b, by substantially 45° or −45°.

Hereinafter, the operation of the liquid crystal display shown in FIG. 10 will be described with reference to FIG. 13. FIG. 13 is a circuit diagram of the liquid crystal display shown in FIG. 10. In FIG. 13, GLa indicates a first gate line, GLb indicates a second gate line, DL indicates a data line, SL indicates a storage wire, PX indicates a pixel electrode, PXa indicates a first sub-pixel electrode, and PXb indicates a second sub-pixel electrode. Further, Qa indicates a first thin film transistor, Qb indicates a second thin film transistor, Clca indicates a liquid crystal capacitor formed between the first sub-pixel electrode and the common electrode, Csta indicates a storage capacitor formed between the first sub-pixel electrode and the storage wire, Clcb indicates a liquid crystal capacitor formed between the second sub-pixel electrode and the common electrode, and Cstb indicates a storage capacitor formed between the second sub-pixel electrode and the storage wire.

Referring to FIG. 13, when a gate-on voltage of, for example, about 20 V is applied to the first gate line GLa, the first thin film transistor Qa is turned on and a first sub-data voltage is applied to the first sub-pixel electrode PXa. Further, a first sub-pixel voltage is charged in the liquid crystal capacitor Clca and storage capacitor Csta. Subsequently, when a gate-off voltage of, for example, about −7 V is applied to the first gate line GLa, the first thin film transistor Qa is turned off. The first sub-pixel voltage charged by the liquid crystal capacitor Clca and storage capacitor Csta is maintained in a liquid crystal layer provided between the first sub-pixel electrode PXa and the common electrode during one frame. Since the alignment angles of the liquid crystals of the liquid crystal layer change on the basis of the charged first sub-pixel voltage, the liquid crystals of the liquid crystal layer alter the phase of light transmitted through the liquid crystals and the transmittance of light transmitted through a polarizer.

Subsequently, when a gate-on voltage of, for example, about 20 V is applied to the second gate line GLb, the second thin film transistor Qb is turned on and a second sub-data voltage is applied to the second sub-pixel electrode PXb. Further, a second sub-pixel voltage is charged in the liquid crystal capacitor Clcb and storage capacitor Cstb. Subsequently, when a gate-off voltage of, for example, about −7 V is applied to the second gate line GLb, the second thin film transistor Qb is turned off. The second sub-pixel voltage charged by the liquid crystal capacitor Clcb and storage capacitor Cstb is maintained in a liquid crystal layer provided between the second sub-pixel electrode PXb and the common electrode during one frame. Since the alignment angles of the liquid crystals of the liquid crystal layer change on the basis of the charged second sub-pixel voltage, the liquid crystals of the liquid crystal layer alter the phase of light transmitted through the liquid crystals and the transmittance of light transmitted through a polarizer.

As described above, the first sub-pixel electrode PXa and second sub-pixel electrode PXb, which form one pixel electrode PX, are driven by different thin film transistors Qa and Qb. Accordingly, it is possible to charge the first sub-pixel electrode PXa and second sub-pixel electrode PXb with different voltages. For example, it is possible to charge the first sub-pixel electrode PXa with a relatively low voltage and to charge the second sub-pixel electrode PXb with a relatively high voltage. In this case, the transmittance of the pixel electrode PX can be calculated as a composition value of the transmittances of the liquid crystals determined by the sub-pixel electrodes PXa and PXb. Accordingly, a gamma curve of one pixel can be expressed as a composition value of two gamma curves, which may help to prevent the distortion of the gamma curve and improve the side visibility.

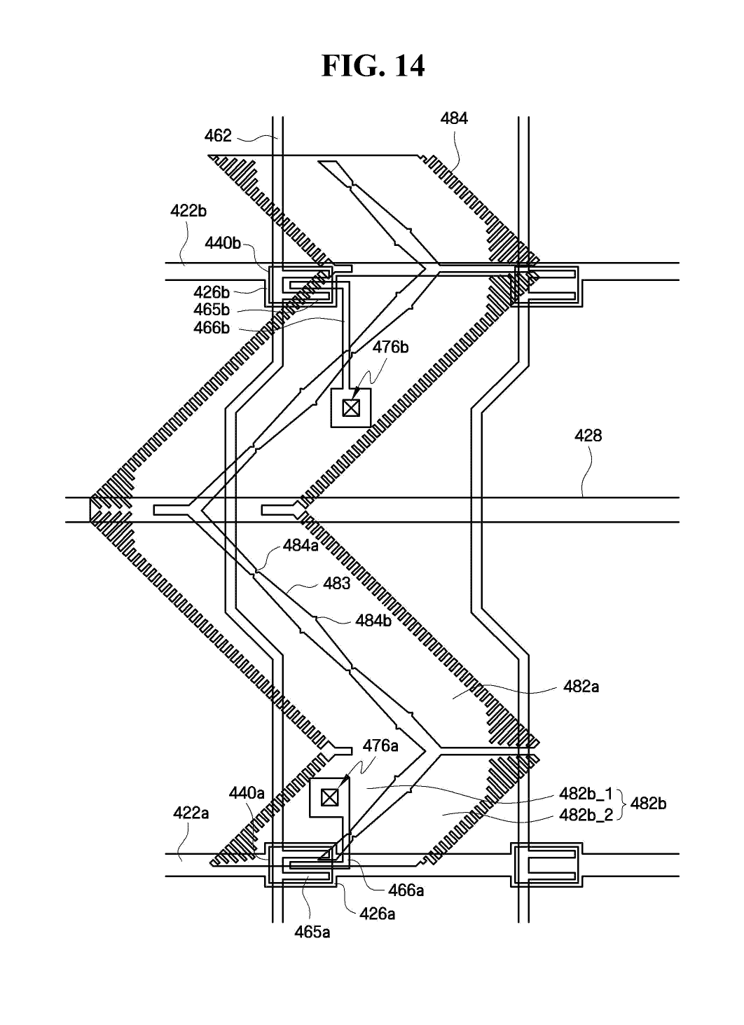

Hereinafter, a liquid crystal display according to still another embodiment of the present invention will be described with reference to FIG. 14. FIG. 14 is a layout view of a thin film transistor array panel for a liquid crystal display according to still another exemplary embodiment of the present invention. For convenience of explanation, components each having the same function for describing the embodiments shown in FIGS. 8 through 13 are respectively identified by the same reference numerals, and their repetitive description will be omitted. The liquid crystal display according to the current embodiment shown in FIG. 14 basically has the same configuration as that of the previous embodiment except for the following.

Serrated micro-patterns 484 are formed at edges of the pixel electrodes 482a and 482b. The serrated micro-patterns 484 strengthen a lateral electric field to thus facilitate movement of the liquid crystal molecules of the liquid crystal layer. The micro-patterns 484 comprise a plurality of protrusions extending perpendicularly from the sides of the pixel electrodes 482a and 482b. Accordingly, the plurality of protrusions constituting the micro-patterns 484 form an angle of approximately 45 degrees or −45 degrees with respect to the first or second gate lines 422a and 422b.

As described above, according to the liquid crystal display of the exemplary embodiments of the present invention, the pixel electrode is divided into two sub-pixel electrodes and the sub-pixel electrodes are driven by different thin film transistors. For this reason, it may be possible to ensure the side visibility. In addition, concave notches and convex notches are alternately arrayed in the gaps formed in the pixel electrode and common electrode, and the side portions of the gaps between the concave notches and convex notches are inclined at predetermined angles. As a result, it may be possible to more effectively prevent the occurrence of display irregularities and residual images at the domain boundaries.

It will be apparent to those skilled in the art that various modifications and variations can be made in the present invention without departing from the scope and spirit of the invention. Therefore, it is intended that the present invention cover the modifications and variations of the invention provided they come within the scope of the appended claims and their equivalents.

What is claimed is:

1. A liquid crystal display, comprising:
a first insulation substrate;
gate lines disposed on the first insulation substrate;
data lines insulated from and crossing the gate lines;
thin film transistors connected to the gate lines and the data lines; and
pixel electrodes divided into a plurality of regions by first domain dividers comprising a plurality of first notches, the pixel electrodes being connected to the thin film transistors,
wherein the width of each first domain divider increases or decreases in a region between the first notches.

2. The liquid crystal display of claim 1, wherein the first notches comprise concave notches and convex notches that are alternately arranged.

3. The liquid crystal display of claim 2, wherein the width of each first domain divider increases while approaching the convex notches from the concave notches.

4. The liquid crystal display of claim 1, wherein the side portions of the first domain dividers are inclined at angles, which are in a range of about 0° to 15°, in the longitudinal direction of the first domain dividers.

5. The liquid crystal display of claim 1, further comprising:
a second insulation substrate facing the first insulation substrate; and
common electrodes disposed on the second insulation substrate, the common electrodes being divided into a plurality of regions by second domain dividers comprising a plurality of second notches,
wherein the first domain dividers and the second domain dividers are alternately arranged to be adjacent to each other, and
the width of each second domain divider increases or decreases in a region between the second notches.

6. The liquid crystal display of claim 5, wherein the second notches comprise concave notches and convex notches that are alternately arranged.

7. The liquid crystal display of claim 6, wherein the width of each second domain divider increases while approaching the convex notches from the concave notches.

8. The liquid crystal display of claim 6, wherein:
the first notches comprise concave notches and convex notches that are alternately arranged;
the concave notches of the first notches correspond to and are disposed adjacent to the concave notches of the second notches; and
the convex notches of the first notches correspond to and are disposed adjacent to the convex notches of the second notches.

9. The liquid crystal display of claim 5, wherein the side portions of the second domain dividers are inclined at angles, which are in a range of about 0° to 15°, in the longitudinal direction of the second domain dividers.

10. The liquid crystal display of claim 1, wherein serrated micro-patterns are formed at edges of the pixel electrodes.

11. The liquid crystal display of claim 10, wherein the serrated micro-patterns comprise a plurality of protrusions extending perpendicularly from the sides of the pixel electrodes.

12. A liquid crystal display, comprising:
a first insulation substrate;
first gate lines and second gate lines separated from each other and disposed on the first insulation substrate;
data lines insulated from and crossing the first gate lines and the second gate lines;
first thin film transistors and second thin film transistors connected to the first gate lines and the second gate lines, respectively, and the data lines;
a first sub-pixel electrode connected to the first thin film transistor; and
a second sub-pixel electrode separated from the first sub-pixel electrode by first domain dividers comprising a plurality of first notches, the second sub-pixel electrode being connected to the second thin film transistor,
wherein the width of each first domain divider increases or decreases in a region between the first notches.

13. The liquid crystal display of claim 12, wherein the first notches comprise concave notches and convex notches that are alternately arranged.

14. The liquid crystal display of claim 13, wherein the width of each first domain divider increases while approaching the convex notches from the concave notches.

15. The liquid crystal display of claim 12, wherein the side portions of the first domain dividers are inclined at angles, which are in a range of about 0° to 15°, in the longitudinal direction of the first domain dividers.

16. The liquid crystal display of claim 12, further comprising:
a second insulation substrate facing the first insulation substrate; and
common electrodes disposed on the second insulation substrate, the common electrodes being divided into a plurality of regions by second domain dividers comprising a plurality of second notches,
wherein the first domain dividers and the second domain dividers are alternately arranged to be adjacent to each other, and
wherein the width of each second domain dividers increases or decreases in a region between the second notches.

17. The liquid crystal display of claim 16, wherein the second notches comprise concave notches and convex notches that are alternately arranged.

18. The liquid crystal display of claim 17, wherein the width of each second domain divider increases while approaching the convex notches from the concave notches.

19. The liquid crystal display of claim 17, wherein:
the first notches comprise concave notches and convex notches that are alternately arranged;
the concave notches of the first notches correspond to and are disposed adjacent to the concave notches of the second notches; and
the convex notches of the first notches correspond to and are disposed adjacent to the convex notches of the second notches.

20. The liquid crystal display of claim 16, wherein the side portions of the second domain dividers are inclined at angles, which are in the range of 0° to 15°, in the longitudinal direction of the second domain dividers.

21. The liquid crystal display of claim 12, wherein the first sub-pixel electrode and the second sub-pixel electrode, as a whole, form a zigzag shape.

22. The liquid crystal display of claim 21, wherein the second sub-pixel electrode comprises a pair of upper and lower electrodes disposed on the upper and lower sides of the first sub-pixel electrode and a side electrode disposed adjacent to the sides of the first sub-pixel electrode and the upper and lower electrodes.

23. The liquid crystal display of claim 22, wherein:
the first sub-pixel electrode is substantially V shaped; and
the side electrode is disposed adjacent to the side of the first sub-pixel electrode and is formed in a zigzag shape comprising three bent portions.

24. The liquid crystal display of claim 12, wherein serrated micro-patterns are formed at edges of the first and second sub-pixel electrodes.

25. The liquid crystal display of claim 24, wherein the serrated micro-patterns comprise a plurality of protrusions extending perpendicularly from the sides of the first and second sub-pixel electrodes.
